(19) United States
(12) Patent Application Publication
(10) Pub. No.: US 2025/0334432 A1
(43) Pub. Date: Oct. 30, 2025

(54) METHOD OF SETTING AN EQUALIZER AND SYSTEM FOR DETERMINING A SETTING OF AN EQUALIZER

(71) Applicant: Rohde & Schwarz GmbH & Co. KG, Muenchen (DE)

(72) Inventor: FranciscoJavier GARCIAGOMEZ, Muenchen (DE)

(21) Appl. No.: 18/650,666

(22) Filed: Apr. 30, 2024

(51) Int. Cl. G01D 21/00

(52) U.S. Cl. CPC G01D 21/00

(57) ABSTRACT

Embodiments of the present disclosure relate to a method of setting an equalizer for a test and/or measurement instrument. The equalizer is preset with pre-defined settings. The input signal is filtered by the equalizer, thereby obtaining an equalized signal. Symbols are detected by processing the equalized signal. The equalizer is set based on the detected symbols. The step of filtering the input signal, the step of detecting symbols, and the step of setting the equalizer are repeated at least once. Further, embodiments of the present disclosure relate to a system for determining a setting of an equalizer to be set.

### FIELD OF THE DISCLOSURE

Embodiments of the present disclosure relate to a method of setting an equalizer for a test and/or measurement instrument. Further, embodiments of the present disclosure relate to a system for determining a setting of an equalizer to be set.

### BACKGROUND

In the state of the art, equalizers are known which are typically used in test and/or measurement instrument. The essential function of an equalizer relates to removing any effects introduced by a signal channel used for processing the signal. The channel may inter alia comprise a signal path over-the-air, a cable connected with the test and/or measurement instrument and/or a signal path within the test and/or measurement instrument. Thus, the channel is not necessarily an internal channel of the test and/or measurement instrument, but can comprise a cable between a transmitter and a receiver. In other words, the equalizer is used to obtain the pure signal without any imperfections and/or deviations introduced.

For instance, a use case of an equalizer of a test and/or measurement instrument is to test a transmitter by applying a compliance channel to it and then setting the equalizer of the test and/or measurement instrument to the settings provided in the standard. It is then verified if the equalizer of the test and/or measurement instrument can open the eye. Here, imperfections and/or deviations are introduced by the compliance channel that is artificially applied to the signal.

Another use case is to debug an equalizer of a receiver by applying the equalizer of the test and/or measurement instrument to the same channel and comparing the performance. In this case, the imperfections and/or deviations are not introduced by the test and/or measurement instrument itself, but by a physical channel that the receiver has to compensate.

In U.S. Pat. No. 8,374,231 B2, a method is described according to which an equalizer is set based on a training sequence. The training sequence is encompassed in a signal processed, wherein the signal is de-embedded so that the training sequence can be easily identified. Based on the training sequence detected, a subsequent equalizer is set, namely by adapting equalizer parameters of the equalizer.

It is further known in the state of the art to use Constant-Modulus Algorithms (CMAs).

However, the techniques and methods known in the state of the art have drawbacks with regard to performance as eyes in eye diagrams of the signals processed are either small or not present.

Accordingly, there is a need for obtaining an improved method and system which ensure equalization of signals in bad channels, e.g. providing larger eyes in eye diagrams.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a method of setting an equalizer for a test and/or measurement instrument. The equalizer is suitable for use in equalizing an input signal comprising symbols. In an embodiment, the method comprises: presetting the equalizer with pre-defined settings; filtering the input signal by the equalizer, thereby obtaining an equalized signal; detecting symbols by processing the equalized signal; setting the equalizer based on the detected symbols; and repeating at least once the filtering of the input signal, the detecting of the symbols, and the setting of the equalizer.

Further, embodiments of the present disclosure provide a system for determining a setting of an equalizer to be set. In an embodiment, the system comprises the equalizer to be set, a signal input connected with an input of the equalizer, a signal line connected with an output of the equalizer, a decision module connected with the signal line, and a setting module connected with the decision module. The equalizer is configured to equalize an input signal with symbols received via the signal input so as to output an equalized signal via the signal line. The decision module includes circuitry configured to detect symbols. The setting module includes circuitry configured to set the equalizer based on the detected symbols. The system is configured to detect the symbols and to set the equalizer based on the detected symbols.

The main idea is to perform a blind and iterative setting of the equalizer which ensures an optimized equalization by the equalizer set. The equalizer that processes the input signal performs a blind estimation of the symbols. Blind estimation means that the equalizer does not know any symbols in the input signal beforehand. The blind estimation involves an iterative attempt to arrive at the optimum equalization of the input signal, namely by setting the equalizer appropriately.

In an embodiment, the input signal is processed with the equalizer to obtain the equalized signal. In the first iteration, the equalizer has a default setting, namely the pre-defined settings. Therefore, the equalized signal according to the first iteration relates to a default equalized signal. From the (default) equalized signal, the symbols are detected, e.g. a symbol sequence, by using the decision module. Finally, the symbols detected as well as the input signal are processed to obtain information based on which the equalizer can be set for the next iteration, namely the second iteration.

In the second iteration, the input signal is processed with the equalizer again which however was set differently. Hence, the equalized signal obtained in the second iteration differs from the (default) equalized signal obtained in the first iteration. Consequently, the symbols detected in the second iteration differ from the ones detected in the first iteration. The recently detected symbols are used together with the input signal in order to obtain information based on which the equalizer can be set for the next iteration.

These actions are repeated iteratively in order to set the equalizer appropriately. With each iteration, the equalizer is set closer to its optimized setting.

Consequently, the method and system differ from known solutions by the facts that an output signal of the equalizer is used for setting the equalizer and that the equalizer is set several times to approach the optimized setting of the equalizer. The optimized setting of the equalizer is obtained in case no further adaption of the setting of the equalizer is no longer necessary.

In an embodiment, the equalizer may be a Feed-Forward Equalizer (FFE).

In an embodiment, the input signal may relate to a PAM-N signal having symbols. For instance, a PAM-2 signal is used, wherein the symbols relate to bits, namely “0” and “1”. Generally, the input signal processed may be a stored or saved signal, for example a stored or saved waveform, which was captured previously.

Accordingly, the input signal may be a sequence of sampled symbols. Thus, the equalizer may process/filter the sequence of sampled symbols.

In an embodiment, the decision module may include circuitry configured to compare the equalized signal with a threshold to decide the respective symbol, namely to detect the symbol accordingly.

In an embodiment, the setting module includes circuitry configured to receive the detected symbols and the input symbols, namely the symbols of the input signal, also called original symbols. The detected symbols are deemed to correspond to a training sequence already encompassed in the input signal. Hence, algorithms may be used for setting the equalizer, which are also used in case of using an input signal with a dedicated training sequence.

An aspect provides, for example, that the actions are repeated iteratively until the detected symbols remain unchanged. In other words, the input signal is equalized by the equalizer in a repetitive manner until the symbols detected by the decision module remain unchanged. The actions repeated are filtering the input signal, detecting symbols, and setting the equalizer. Hence, these actions may be repeated iteratively, namely several times. Actually, it was found that the detected symbols typically remain unchanged after four or five iterations. Consequently, the equalizer is set appropriately until these iterations.

A further aspect provides, for example, that the equalizer is set based on the detected symbols and the input signal. The setting module is connected with the signal input and the decision module so as to set the equalizer based on the detected symbols and the input signal. Hence, the decision module may take the detected symbols, e.g. the ones provided by the decision module, and the input signal received via the signal input into account for setting the equalizer. As indicated above, this is done in an iterative manner provided that the detected symbols differ from the ones detected in the previous iteration.

According to another aspect, equalizer parameters, for example, are determined by processing the detected symbols, wherein the equalizer is set by adjusting at least one equalizer parameter.

In an embodiment, the input signal may be an unknown signal. Hence, the input signal does not relate to a test signal with known symbols or symbol sequence. In other words, the symbols or symbol sequence of the input signal is unknown. Therefore, the equalizer is set in a blind manner, as no information with regard to the symbols and/or the symbol sequence is known previously.

In an embodiment, the input signal is filtered by the equalizer without de-embedding the input signal previously. Consequently, the input signal not de-embedded before the equalized signal is obtained. In contrast to a de-embedding and a subsequent equalization for setting the equalizer, the equalizer is set by multiple equalizations performed by the equalizer while having different settings.

Hence, the equalizer may be set without de-embedding the input signal. In an embodiment, the equalizer is set based on multiple equalizations performed while the equalizer has different settings.

Another aspect provides, for example, that a user manually starts the method by interacting with a user interface. The system may have a user interface via which the user may manually start the method. In an embodiment, a button may be provided, e.g. a button on a graphical user interface, which is used by the user for starting the method manually. For instance, the button may be labelled by “Set equalizer” or “Train equalizer” or similar.

In an embodiment, the symbols of the input signal may provide a protocol information of the input signal. Hence, the symbols relate to a certain symbol sequence that is indicative of a protocol, for instance a telecommunication standard. The protocol information may relate to a serial standard/protocol, e.g. universal serial bus (USB), Inter-integrated circuit (I2C), Peripheral Component Interconnect Express (PCIe), or Ethernet.

According to an embodiment, a clock is known when processing the equalized signal in order to detect the symbols. Hence, the decision module includes circuitry configured to directly process the equalized signal in order to detect the symbols from the equalized signal.

According to another embodiment, the system may comprise a clock recovery module that is connected with the signal line. In an embodiment, the clock recovery module includes circuitry configured to process the equalized signal and output a clock signal. Hence, it is also possible to determine/estimate the clock, namely to perform a clock recovery based on the equalized signal, provided that the clock is not known.

In other words, a clock is recovered by processing the equalized signal, wherein equalized symbols are determined based on the clock recovered and the equalized signal. Hence, a resampling of the equalized signal takes place once the clock was recovered from the equalized signal.

For this purpose, the system may, for example, comprise a resampling module that is connected with the signal line and the clock recovery module so as to obtain the equalized signal from the signal line and the clock signal from the clock recovery module. In an embodiment, the resampling module includes circuitry configured to process the clock signal and the equalized signal in order to determine and output the equalized symbols.

In an embodiment, the symbols may be detected based on the equalized symbols. In other words, the decision module may be connected with the resampling module. Then, circuitry of the decision module is configured to detect the symbols based on the equalized symbols. Accordingly, the decision module does not directly process the equalized signal, but indirectly since the decision module processed the equalized symbols derived from the equalized signal when resampling the equalized signal by the resampling module.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a system for determining a setting of an equalizer to be set according to an embodiment of the present disclosure,

FIG. 2 schematically shows a system for determining a setting of an equalizer to be set according to another embodiment of the present disclosure, and

FIG. 3 schematically shows an example of a flow-chart of a method of setting an equalizer for a test and/or measurement instrument according to an embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

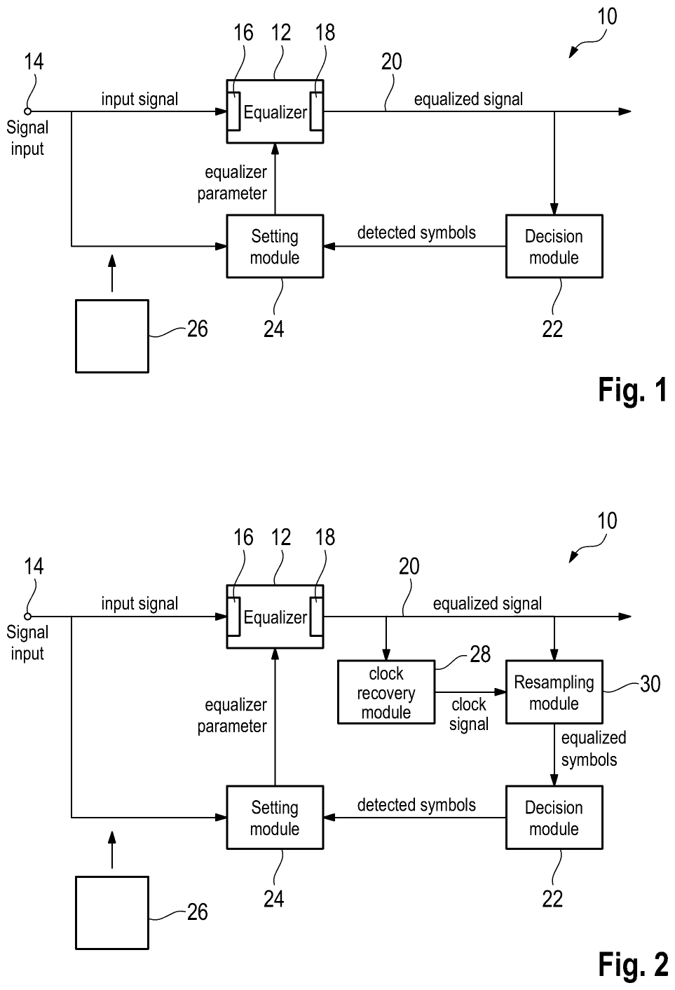

In FIG. 1, a system 10 for determining a setting of an equalizer 12 to be set is shown according to an embodiment of the present disclosure. The system 10 comprises a signal input 14 for receiving an input signal with symbols. The input signal may relate to a stored signal/waveform, namely a sequence of symbols. The sequence of symbols may be indicative of a protocol, namely a telecommunication standard, for instance a serial standard/protocol, e.g. universal serial bus (USB), Inter-integrated circuit (I2C), Peripheral Component Interconnect Express (PCIe), or Ethernet.

However, the input signal is an unknown signal which means that the symbols contained in the input signal are not known, for example to the equalizer 12. In other words, the sequence of symbols contained in the input signal does not relate to a training sequence.

The signal input 14 is connected with an input 16 of the equalizer 12 such that the input signal is forwarded to the equalizer 12 that equalizes the input signal in order to obtain an equalized signal. At the beginning, the equalizer 12 has a default setting which comprises pre-defined equalization parameters based on which the input signal is filtered by the equalizer 12. The equalizer 12 also has an output 18 that is connected with a signal line 20 such that the equalized signal is outputted via the output 18 for further processing.

In the embodiment of FIG. 1, the system 10 comprises a decision module 22 that is connected with the signal line 20. In the shown embodiment, the decision module 22 directly obtains the equalized signal from the signal line 20. The decision module 22 includes circuitry configured to compare the equalized signal received with a threshold to decide the respective symbols, namely to detect the symbols. In an embodiment, the decision module 22 may use a known clock for symbol detection accordingly.

In an embodiment, the system 10 also comprises a setting module 24 that is connected with the decision module 22. Hence, the detected symbols are forwarded to the setting module 24 that also receives the original symbols, namely the input symbols, e.g. the symbols of the input signal.

In an embodiment, the setting module 24 includes circuitry configured to determine equalizer parameters by processing the detected symbols and the input signal, namely the symbols of the input signal. At least one equalizer parameter is adapted by the setting module 24 in order obtain a new setting used for equalizing the input signal by the equalizer 12.

Hence, the equalizer 12 is set by the setting module 24 based on the input signal and the detected symbols. As indicated above, the detected symbols are obtained when processing the equalized signal outputted by the equalizer 12.

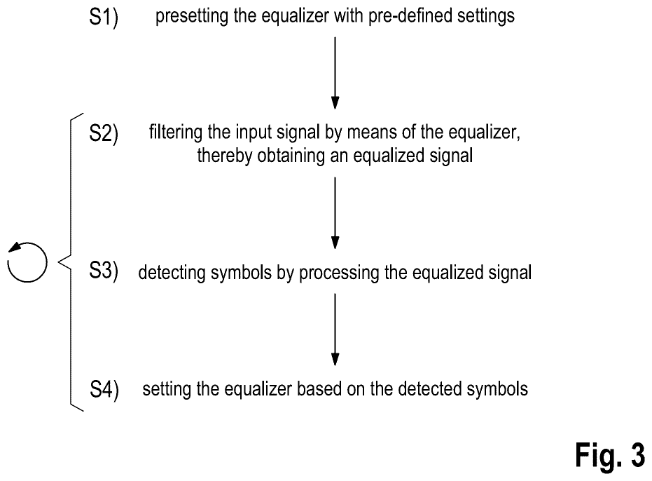

In FIG. 3, one example is shown for setting the equalizer 12. As indicated in FIG. 3, the equalizer 12 is preset with pre-defined settings in a first step S1 such that the input signal can be equalized in a default manner by the equalizer 12. In a second step S2, the equalizer 12 having the default setting filters the input signal, thereby obtaining the (preliminary/default) equalized signal. In a third step S3, the (preliminary/default) equalized signal is processed further by the decision module 22 in order to detect symbols.

In a fourth step S4, the detected symbols are processed further by the setting module 24, for example together with the input signal, e.g. the symbols of the input signal prior to being equalized. Based on this processing, values for at least one equalizer parameter, for example for several equalizer parameters, may be determined, wherein the value of at least one equalizer parameter is adapted so as to set the equalizer 12.

Afterwards, the input signal is filtered again by the re-set equalizer 12 so as to obtain a new equalized signal which is processed by the decision module 22 in order to detect new symbols based on which values for at least one equalizer parameter are determined so as to adapt at least one. In other words, the steps S2 to S4 are repeated, for example several times, e.g. three times, four times or five times. In an embodiment, the steps S2 to S4 are repeated iteratively until the detected symbols remain unchanged. Once the detected symbols correspond to the ones detected previously, it is assumed that the equalizer 12 has been set in an optimized manner.

Consequently, the entire setting of the equalizer 12 is obtained by an iterative process. However, it is not necessary to perform a de-embedding of the input signal previously. Therefore, the equalizer 12 is set without de-embedding the input signal.

Generally, a user manually starts the method by interacting with a user interface 26 of the system 10.

In FIG. 2, another embodiment of the system 10 is shown which differs from the embodiment of FIG. 1 in that the clock is not known. In other words, the clock has to be recovered for determining the symbols of the equalized signal, namely the equalized signal.

Accordingly, the system 10 comprises a clock recovery module 28 that is connected with the signal line 20. In an embodiment, the clock recovery module 28 includes circuitry configured to process the equalized signal and outputs a clock signal.

The clock signal is forwarded to a resampling module 30 that is connected with the signal line 20 and the clock recovery module 28. Hence, the circuitry of the resampling module 30 is configured to receive the equalized signal from the signal line 20 and the clock signal from the clock recovery module 28. In an embodiment, circuitry of the resampling module 30 processes the equalized signal and the clock signal in order to sample equalized symbols that are outputted.

In an embodiment, the equalized symbols sampled by the resampling module 30 are forwarded to the decision module 22 which detects the symbols based on the equalized symbols. In an embodiment, the decision module 22 forwards the detected symbols to the setting module 24 as described above with respect to the first embodiment according to FIG. 1.

Accordingly, a blind and iterative setting of the equalizer 12 is performed in order to ensure an optimized equalization by the equalizer 12 once the equalizer 12 is set appropriately. Hence, the equalizer 12 processes the input signal while performing a blind estimation of the symbols of the input signal simultaneously. The blind estimation involves an iterative attempt to arrive at the optimum equalization of the input signal, namely by setting the equalizer 12 appropriately.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components, such as the equalizer 12, the decision module 22, the setting module 24, the user interface 26, the clock recovery module 28, the resampling module 30, etc., referenced above include circuitry programmed to carry out one or more steps or actions of any of the methods disclosed herein. In an embodiments, one or more computer-readable media associated with or accessible by such circuitry contains computer readable instructions embodied thereon that, when executed by such circuitry, cause the component or circuity to perform one or more steps or actions of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible to a computing device, such as processor circuitry, etc., or other circuity disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A method of setting an equalizer for a test and/or measurement instrument, wherein the equalizer is used for equalizing an input signal comprising symbols, the method comprising the steps of:
presetting the equalizer with pre-defined settings,
filtering the input signal by the equalizer, thereby obtaining an equalized signal,
detecting symbols by processing the equalized signal,
setting the equalizer based on the detected symbols, and
repeating at least once the step of filtering the input signal, the step of detecting symbols, and the step of setting the equalizer.

2. The method according to claim 1, wherein the steps are repeated iteratively until the detected symbols remain unchanged.

3. The method according to claim 1, wherein the equalizer is set based on the detected symbols and the input signal.

4. The method according to claim 1, wherein equalizer parameters are determined by processing the detected symbols, and wherein the equalizer is set by adjusting at least one equalizer parameter.

5. The method according to claim 1, wherein the input signal is an unknown signal.

6. The method according to claim 1, wherein the input signal is filtered by the equalizer without de-embedding the input signal previously.

7. The method according to claim 1, wherein the equalizer is set without de-embedding the input signal.

8. The method according to claim 1, wherein a user manually starts the method by interacting with a user interface.

9. The method according to claim 1, wherein the symbols of the input signal provide a protocol information of the input signal.

10. The method according to claim 1, wherein a clock is known when processing the equalized signal in order to detect the symbols.

11. The method according to claim 1, wherein a clock is recovered by processing the equalized signal, and wherein equalized symbols are determined based on the clock recovered and the equalized signal.

12. The method according to claim 11, wherein the symbols are detected based on the equalized symbols.

13. A system for determining a setting of an equalizer to be set, the system comprises:
the equalizer to be set;
a signal input connected with an input of the equalizer;
a signal line connected with an output of the equalizer;
a decision module connected with the signal line; and
a setting module connected with the decision module,
wherein the equalizer is configured to equalize an input signal with symbols received via the signal input so as to output an equalized signal via the signal line,
wherein the decision module includes circuitry configured to detect symbols,
wherein the setting module includes circuitry configured to set the equalizer based on the detected symbols, and
wherein the system is configured to detect the symbols and to set the equalizer based on the detected symbols.

14. The system according to claim 13, wherein the input signal is equalized by the equalizer in a repetitive manner until the symbols detected by the decision module remain unchanged.

15. The system according to claim 13, wherein the setting module is connected with the signal input and the decision module so as to set the equalizer based on the detected symbols and the input signal.

16. The system according to claim 13, wherein the decision module includes circuitry configured to directly process the equalized signal in order to detect the symbols from the equalized signal.

17. The system according to claim 13, further comprising a clock recovery module that is connected with the signal line, wherein the clock recovery module includes circuitry configured to process the equalized signal and output a clock signal.

18. The system according to claim 17, further comprising a resampling module that is connected with the signal line and the clock recovery module so as to obtain the equalized signal from the signal line and the clock signal from the clock recovery module, wherein the resampling module includes circuitry configured to output equalized symbols.

19. The system according to claim 18, wherein the decision module is connected with the resampling module, and wherein the decision module includes circuitry configured to detect the symbols based on the equalized symbols.
